(19) United States
(12) Patent Application Publication
(10) Pub. No.: US 2011/0262198 A1
(43) Pub. Date: Oct. 27, 2011

(54) SHEET HOLDING DEVICE AND IMAGE FORMING APPARATUS (PINION HOLDER IN SHEET FEEDER CASSETTE)

(75) Inventor: Yousuke USHIYAMA, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/043,435

(22) Filed: Mar. 8, 2011

Related U.S. Application Data
(60) Provisional application No. 61/326,568, filed on Apr. 21, 2010.

(51) Int. Cl. G03G 15/00; B65H 1/00

(52) U.S. Cl. 399/393; 271/171

(57) ABSTRACT

According to one embodiment, a sheet holding device including a guiding member that defines a sheet position in a sheet width direction which is perpendicular to a sheet movement direction, a rack gear that assists a movement in the sheet width direction of the guiding member, a pinion gear that assists the movement in the sheet width direction of the guiding member in cooperation with the rack gear, and a holder that supports the rack gear and the pinion gear movable in the sheet width direction in a state of maintaining a positional relation between the rack gear and the pinion gear, and provides an effect on a load applied to the guiding member from a direction which is perpendicular to each of the sheet movement direction and the sheet width direction.

### CROSS-REFERENCE TO RELATED APPLICATIONS

This application is based upon and claims the benefit of priority from: U.S. Provisional Application No. 61/326,568 filed on Apr. 21, 2010, the entire contents of each of which are incorporated herein reference.

### FILED

Embodiments described herein relates generally to an image forming apparatus and a sheet holding device.

### BACKGROUND

A toner (a visualizing agent) moves to a sheet medium on the basis of image information and is integrated with the sheet medium. The sheet medium (integrated with the toner) is a hard copy.

A sheet holding device receives the sheet medium. Whenever an output of the hard copy is required, the sheet medium moves sheet by sheet from the sheet holding device to a position to which the toner moves (the sheet movement direction is a direction in which the sheet medium moves to the position to which the toner moves).

When the sheet holding device moves to a direction perpendicular to the sheet movement direction (the movement direction of the sheet medium to the position to which the toner moves), in relation to the direction perpendicular to the sheet movement direction, sometimes a position of a sidewall (a guiding member) managing the position of the sheet medium cannot be maintained (the position of the side wall is changed).

### BRIEF DESCRIPTION OF THE DRAWINGS

A general architecture that implements the various features of the embodiments will now be described with reference to the drawings. The drawings and the associated descriptions are provided to illustrate embodiments and not to limit the scope of the embodiments.

FIG. 1 is an exemplary diagram showing an example of an MFP, according to an embodiment;

FIG. 2 is an exemplary diagram showing an example of the MFP, according to an embodiment;

FIG. 3 is an exemplary diagram showing an example of a sheet holder of the MFP according to an embodiment;

FIG. 4 is an exemplary diagram showing an example of the sheet holder of the MFP according to an embodiment;

FIG. 5 is an exemplary diagram showing an example of the sheet holder of the MFP according to an embodiment;

FIG. 6 is an exemplary diagram showing an example of the sheet holder path of the MFP according to an embodiment;

FIG. 7 is an exemplary diagram showing an example of the sheet holder of the MFP, according to an embodiment; and

FIG. 8 is an exemplary diagram showing an example of the sheet holder of the MFP, according to an embodiment.

### DETAILED DESCRIPTION

In general, according to an embodiment, a sheet holding device comprising: a guiding member that defines a sheet position in a sheet width direction which is perpendicular to a sheet movement direction; a rack gear that assists a movement in the sheet width direction of the guiding member; a pinion gear that assists the movement in the sheet width direction of the guiding member in cooperation with the rack gear; and a holder that supports the rack gear and the pinion gear movable in the sheet width direction in a state of maintaining a positional relation between the rack gear and the pinion gear, and provides an effect on a load applied to the guiding member from a direction which is perpendicular to each of the sheet movement direction and the sheet width direction.

Embodiments will now be described hereinafter in detail with reference to the accompanying drawings.

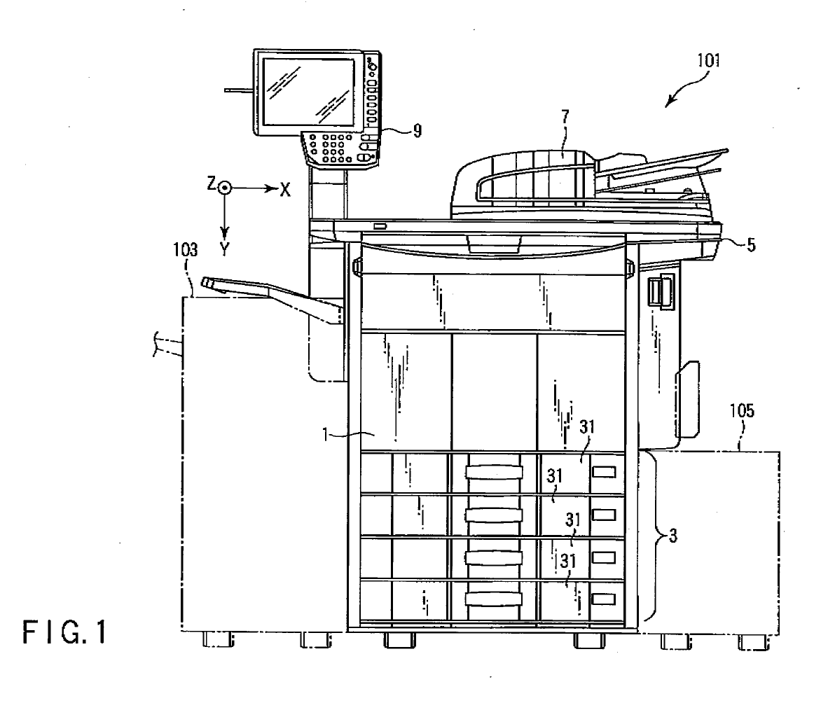

FIG. 1 schematically shows an MFP (Multi-Functional Peripheral) to which the embodiment is able to apply.

An MFP101 includes an image forming section (a printer section) 1 for outputting image information as an output image which is referred to as a hard copy or a print out, a sheet feeder 3 to supply a sheet medium having an optional size, which is used for an image output, to the image forming section 1, and a scanner section 5 to provide image data of an original to the image forming section 1.

Moreover, the scanner section 5 integrally has an automatically-document feeder (ADF) 7 the original to a reading position on the scanner section 5.

A control panel 9 for giving an instruction for starting image formation in the image forming section 1 and starting to read image information of the original through the scanner section 5 is placed in a strut 9a fixed to the image forming section 1 and a swing arm 9b in a corner at a left or right side behind the scanner section 5.

In many MFPs, the sheet feeder 3 includes two or more sheet holding devices, that is, cassettes 31.

Currently, in many MFPs, a saving of space for installing the MFP 101 is required, and the respective cassettes 31 (of the sheet feeder 3) can be connected with a finisher 103 for processing the output hard copy and be connected with an LCF (Large Capacity Feeder) 105 for receiving twice the amount or more of sheet media as compared to the two or more cassettes. Therefore, in terms of the sheet media supply or the like, each cassette 31 has a configuration of moving to a front side (Z direction). Hereinafter, the Z direction is defined as the cassette movement direction. Further, the X direction is defined as the sheet medium movement direction.

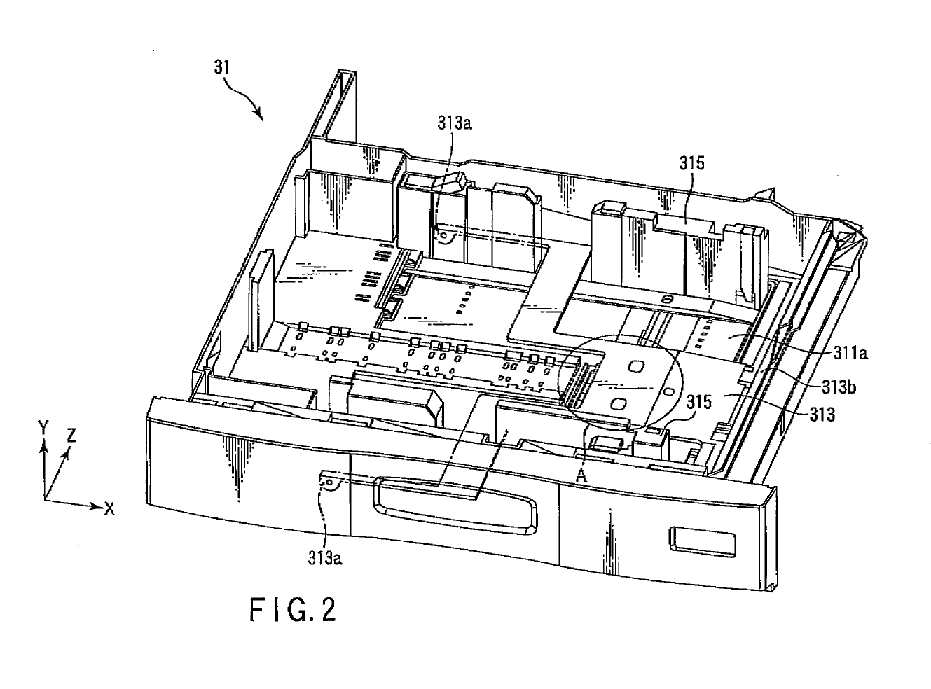

FIG. 2 shows that a state where the cassette is drawn out (from MFP 1) to the Z direction of FIG. 1, that is, the cassette movement direction. The cassette includes a casing (housing) 311 for receiving the sheet media and an element described below, a tray 313 for holding the sheet media within the casing 311, and a pair of guides 315 for setting a position in the Z direction of the sheet media held by the tray 313.

The tray 313 can be pivoted with a supporting point 313a through a center in respect to a bottom surface 311a of the casing 311. The pivoting of the tray 313 causes an opening end 313b (a free end opposite to the supporting point 313a) of the tray 313 to be displaced in the Y direction. By the displacement of the tray 313, the sheet media held by the tray 313 moves from the cassette 31 toward the image forming section 1. Therefore, (from the cassette 31) the sheet media move to a position which abuts to a pickup roller for pulling out (taking out) the sheet medium.

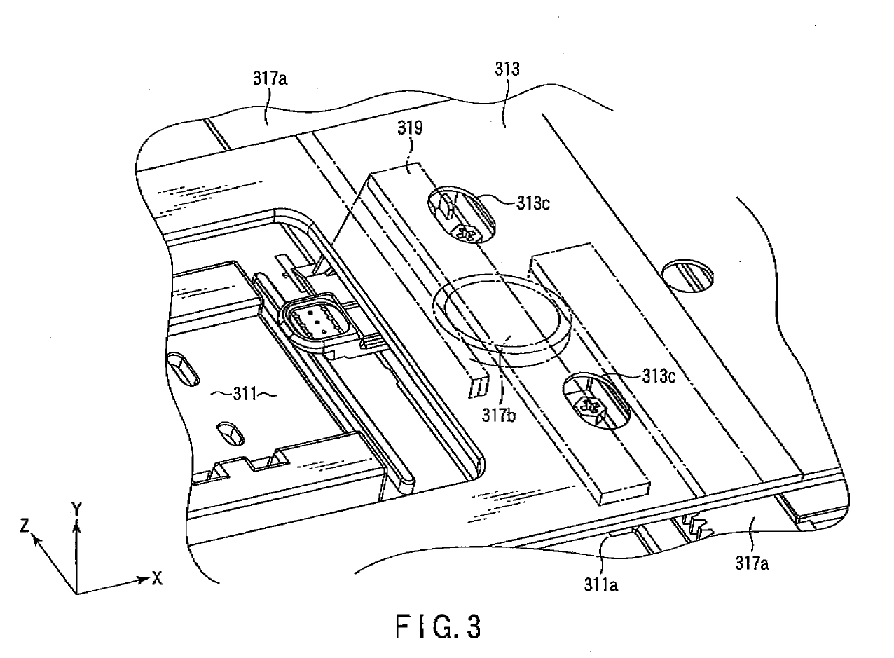

The guide 315 inhibits variation in the (Z direction) position of the sheet media disposed on the tray 313. Further, the guide 315 includes a configuration described below with reference to FIG. 3 to FIG. 8. Accordingly, the movement direction of the sheet medium held by the cassette 31 and a center position in a width direction of the sheet medium which is perpendicular to the movement direction of the sheet medium may be relatively varied in the casing 311.

For example, the relative variation of the center position in the sheet medium width direction is beneficial for aligning a center of an output image corresponding to image data and the center in the sheet medium width direction in the cassette 31 such as when a misalignment occurs between the two centers. Similarly, for example, in an MFP 101 having a configuration in which a finisher 103 is connected, when the finisher 103 moves the sheet medium, the relative variation is beneficial for aligning a center in the sheet medium width direction and the center in the sheet medium width direction in the cassette 31 such as when a misalignment occurs between the two centers.

FIG. 3 shows an enlarged portion A of the cassette shown in FIG. 2.

In FIG. 3, between the bottom surface 311a of the casing 311 of the cassette 31 and the tray 311, (two) racks (gear) 317a connecting to each of the guides 315, a pinion (gear) 317b connecting to the respective rack (gear) 317a, and a holder 319 covering the rack (gear) and the pinion (gear) from the tray 313 side are disposed.

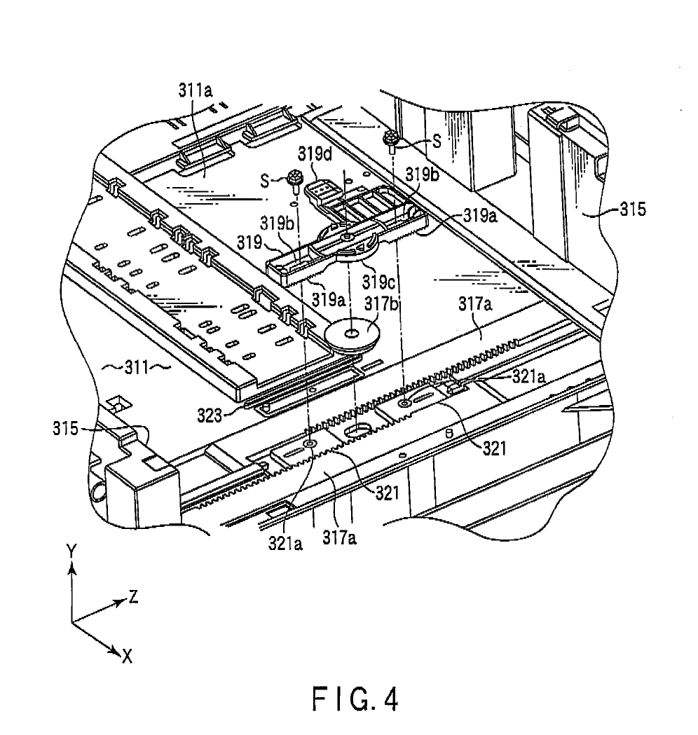

FIG. 4 shows a vicinity of the tray 313, the holder 319, the rack (gear) 317a and the pinion (gear) 317b shown in FIG. 3 in a partial and enlarged manner.

The bottom surface 311a of the casing 311 includes a screw hole 321a (two places) in which the holder 319 can be fixed by (two) screws S. A bottom surface side rack gear 321 supporting the holder 319 is disposed at (two places at) a periphery of the screw hole 321a. The bottom surface side rack gear 321 interlocks with (two) holder side rack gears 319a of the holder 319. The bottom surface side rack gear 321 and the holder side rack gear 319a define a plurality of interlocking (engagement) positions in the Z direction (the cassette movement direction) with respect to each other.

The holder 319 includes (two) screw holes 319b placed at a distance in the Z direction, a pinion holding portion 319c defining a position of the pinion (gear) 317b between the screw holes, and a pressing portion (a force applying point) 319d which is perpendicular to a line segment connecting the screw hole 319b and the pinion holding portion 319c and is situated at a predetermined position at a distance in the X direction from the line segment.

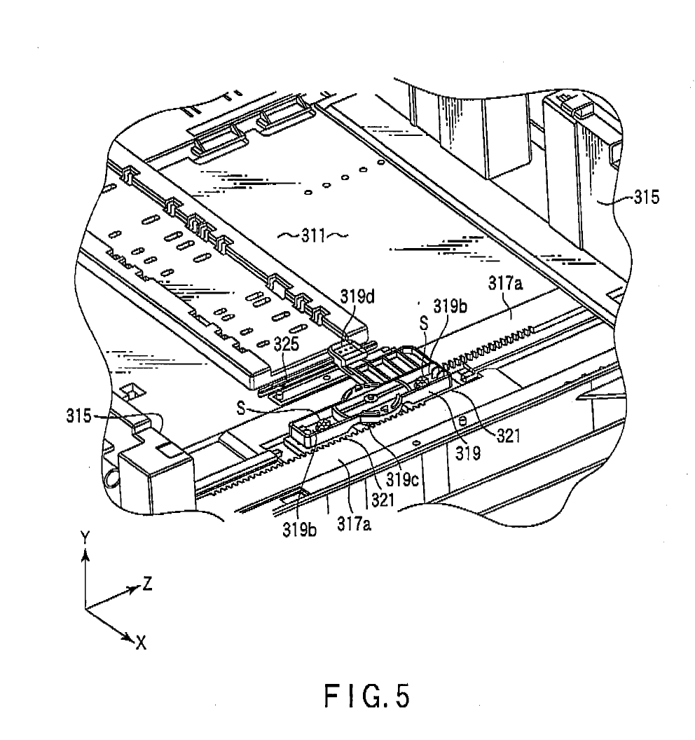

FIG. 5 shows a state where the holder 319 shown in FIG. 4 is connected with the bottom surface 311a of the casing by the screw S. FIG. 5 shows an example in which the holder side rack gear 319a of the holder 319 interlocks with the bottom side rack gear 321 of the bottom surface 311a of the casing 311 and the pinion holding portion 319c is situated at a predetermined position (prepared so that the pinion (gear) 317b is positioned) of the bottom surface 311a of the pinion (gear) 317b.

In the state shown in FIG. 5, the pinion (gear) 31′7b connects to (two) racks (gear) 317a connecting with the respective guides 315. Accordingly, if one of the guides 315 moves to the Z direction, the other guide 315 also moves. At this time, a position in the Z direction of the sheet media situated on the tray 313 is defined between both guides 315 as an approximate center to the pinion (gear) 317b. Therefore, substantially, the position of the pinion (gear) 317b (the Z direction) indicates the center in the width direction (the Z direction) of the sheet media.

Moreover, in a position with a distance in the X direction length of the rack (gear) 317a connecting with the one of the guides 315, from the bottom surface 311a of the casing 311 to the Y direction, the pressing portion (the force applying point) 319d of the holder 319 is opposite to a stopper portion 323 having a predetermined height in a state with a predetermined distance to the stopper portion 323. Here, the X direction length is perpendicular to a direction (the Z direction) in which a gear train of the rack (gear) 317a is lined up (is formed) and is parallel with the sheet medium movement direction.

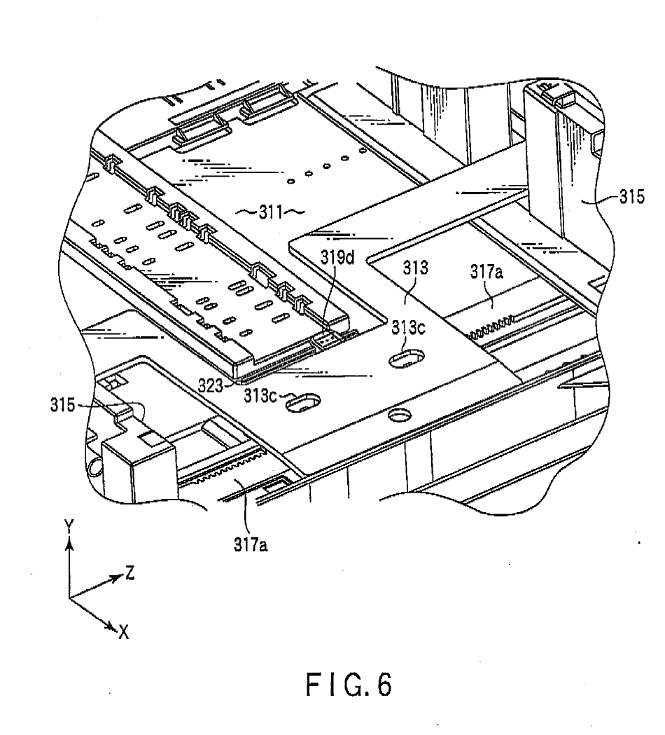

FIG. 6 shows a state where the tray 313 is positioned from the holder 319 side in a state where the holder 319 shown in FIG. 5 connects to the bottom surface 311a of the casing.

The tray 313 includes (two places) access openings 313c so that the holder 319 accesses a screw S which is connected to the casing 311 in a state where the rack gear 319a of the holder 319 interlocks with the bottom side rack gear 321 without moving the tray 313.

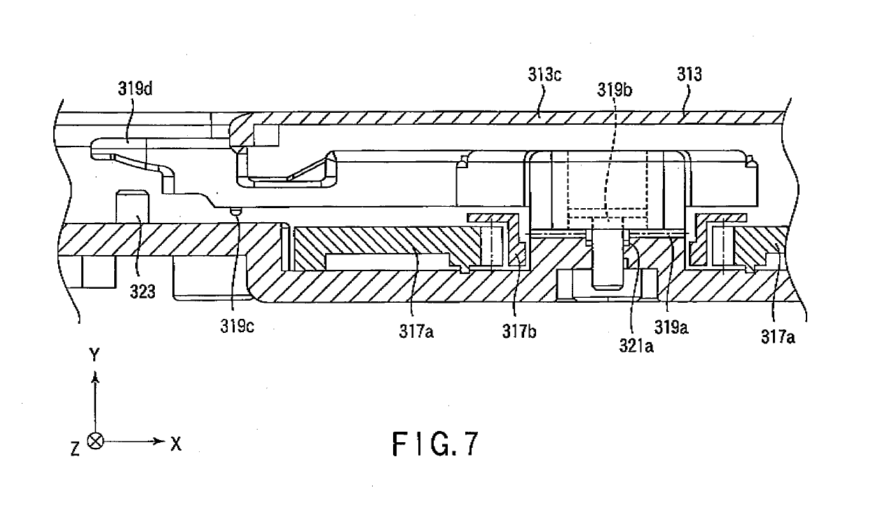

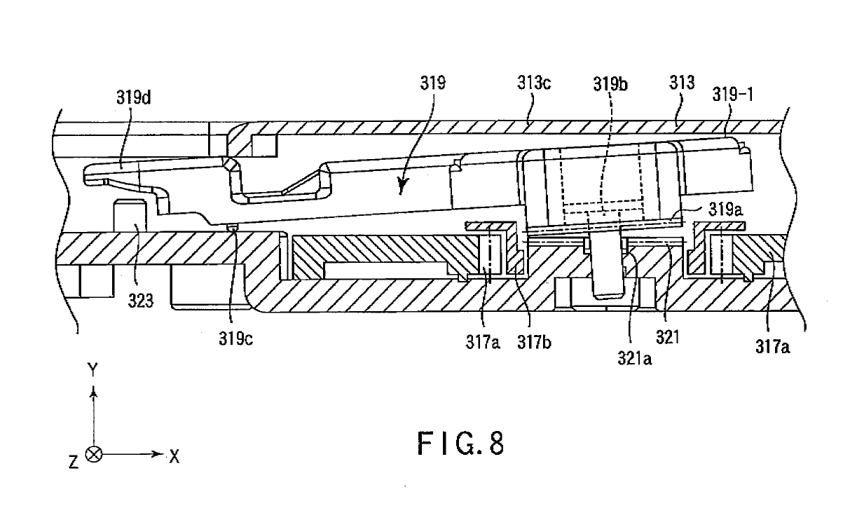

FIG. 7 and FIG. 8 show a state of the holder 319 when the holder 319, the rack (gear) 317a (two), the pinion (gear) 317b and the bottom surface 311a of the casing 311 are cut along to a cross section including a center of the pinion (gear) 317b and extending in the X direction. Further, FIG. 7 shows a static state (the pressing force is not applied to the holder 319) in the cross section, and FIG. 8 shows a state where the pressing force is applied to the holder 319 (the pressing portion (the force applying point) 319d is pressed) in the cross section shown in FIG. 7.

As shown in FIG. 7, from a state where the rack gear 319a of the holder 319 interlocks with the bottom surface side rack gear 321 of the bottom surface 311a of the casing 311 and the pinion (gear) 317b interlocks with two racks (gears) 317a, if the screw S is loosened (through the access opening 313c formed in the tray 313) by a constant amount (it is not to fully removed) and the pressing portion (the force applying point) 319d as shown in FIG. 8 is pressed, a supporting point configuration 319e (a rib or a protrusion) of the holder 319 abuts to a predetermined position of the bottom surface 311a of the casing 311.

As a result, the rack gear 319a side of the holder 319 is lifted through the principle of “leverage” with the supporting point configuration (the rib or the protrusion) 319e as a supporting point. Herewith, the interlocking between the rack gear 319a and the rack gear 321 is weak, and the holder 319 is movable in the Z direction. Accordingly, the center position in the width direction of the sheet media can be adjusted without changing the positional relations of the guide 315, the rack (gear) 317a and the pinion (gear) 317b. Further, since a maximum value of a pressing amount of the pressing portion (the force applying point) 319d of the holder 319 is managed by abutting the stopper portion 323 of the casing 311, even if the screw S fully comes out, it is possible to secure a state where the interlocking between the rack gear 319a and the rack gear 321 slightly remains or a state where the interlock just deviates, and a state where the pinion (gear) 317b does not fall out from the holder 319.

Moreover, since the pressing portion (the force applying point) 319d of the holder 319 and a predetermined position 319-1 which is the opposite side to the pressing portion abut to the tray 313, (similarly to the above) it is possible to secure a state where the pinion (gear) 317b does not fall out from the holder 319.

According to the above configuration, in relation to the direction in which the sheet holding device (the cassette) is perpendicular to the sheet movement direction (the movement direction of the sheet medium to the position to which the toner moves), the positions of the side walls (the guiding members) managing the position of the sheet medium do not change due to the weight of the sheet medium.

Accordingly, it is possible to suppress the occurrence of the misalignment between the center of an output image corresponding to image data and the center in the sheet medium width direction in the sheet holding device.

Moreover, for example, in an MFP having a configuration in which a finisher is connected, in regard to a case such as when the misalignment occurs between a center in the sheet medium width direction when the finisher moves the sheet medium and the center in the sheet medium width direction in the sheet holding device, it is possible to align the two centers without needing a complicated process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sheet holding device comprising:
a guiding member that defines a sheet position in a sheet width direction which is perpendicular to a sheet movement direction;
a rack gear that assists a movement in the sheet width direction of the guiding member;
a pinion gear that assists the movement in the sheet width direction of the guiding member in cooperation with the rack gear; and
a holder that supports the rack gear and the pinion gear movable in the sheet width direction in a state of maintaining a positional relation between the rack gear and the pinion gear, and provides an effect on a load applied to the guiding member from a direction which is perpendicular to each of the sheet movement direction and the sheet width direction.

2. The device of claim 1, further comprising:
a casing that supports the holder.

3. The device of claim 2, wherein the casing includes a stopper configuration which inhibits movement of the holder by a load in the sheet width direction applied to the guiding member.

4. The device of claim 3, wherein the holder includes a stopper configuration which is connected with the stopper of the casing and inhibits movement of the holder by a load in the sheet width direction applied to the guiding member.

5. The device of claim 4, wherein the holder includes a configuration in which a stopper of a holder itself moves in the direction which is perpendicular to each of the sheet movement direction and the sheet width direction so that the stopper of the holder is releasable from a connection with the stopper of the casing.

6. The device of claim 5, wherein the holder includes a protrusion that provides a supporting point in relation to the moving configuration.

7. The device of claim 5, wherein the casing includes a regulation member that regulates a movement amount of the moving configuration of the holder.

8. A sheet cassette comprising:
a guiding member that defines a sheet position in a sheet width direction which is perpendicular to a sheet movement direction;
a rack gear that assists a movement in the sheet width direction of the guiding member;
a pinion gear that assists the movement in the sheet width direction of the guiding member in cooperation with the rack gear;
a holder that supports the rack gear and the pinion gear movable in the sheet width direction in a state of maintaining a positional relation between the rack gear and the pinion gear, and provides an effect on a load applied to the guiding member from a direction which is perpendicular to each of the sheet movement direction and the sheet width direction; and
a tray that covers the rack gear, the pinion gear, and the holder from the direction which is perpendicular to each of the sheet movement direction and the sheet width direction, and receives a load of a sheet medium.

9. The cassette of claim 8, further comprising:
a casing that supports the holder.

10. The cassette of claim 9, wherein the casing includes a stopper configuration which inhibits movement of the holder by a load in the sheet width direction applied to the guiding member.

11. The cassette of claim 10, wherein the holder includes a stopper configuration which is connected with the stopper of the casing and inhibits movement of the holder by a load in the sheet width direction applied to the guiding member.

12. The cassette of claim 11, wherein the holder includes a configuration in which the stopper of the holder itself moves in the direction which is perpendicular to each of the sheet movement direction and the sheet width direction so that the stopper of the holder is releasable from a connection with the stopper of the casing.

13. The cassette of claim 12, wherein the holder includes a protrusion that provides a supporting point about the moving configuration.

14. The cassette of claim 12, wherein the casing includes a regulation member that regulates a movement amount of the moving configuration of the holder.

15. The cassette of claim 11, further comprising:
a screwed mount configuration that provides a predetermined fastening force between the screw configuration and the casing in a state where the stopper of the holder and the stopper of the casing are connected to each other.

16. The cassette of claim 15, wherein the tray includes an opening to access to the screw configuration of the holder without changing the position of the tray.

17. The cassette of claim 16, wherein the holder includes a configuration in which the stopper of the holder itself moves in the direction which is perpendicular to each of the sheet movement direction and the sheet width direction so that the stopper of the holder is releasable from a connection with the stopper of the casing in a state where the predetermined fastening force is released by the screw configuration.

18. The cassette of claim 17, wherein the holder includes a protrusion that provides a supporting point in relation to the moving configuration.

19. The cassette of claim 17, wherein the casing includes a regulation member that regulates a movement amount of the moving configuration of the holder.

20. An image forming apparatus comprising:
an image forming section that forms an image visualized by toner;
a sheet cassette including
a guiding member that defines a sheet position in a sheet width direction which is perpendicular to a sheet movement direction;
a rack gear that assists a movement in the sheet width direction of the guiding member;
a pinion gear that assists the movement in the sheet width direction of the guiding member in cooperation with the rack gear;
a holder that supports the rack gear and the pinion gear movable in the sheet width direction in a state of maintaining a positional relation between the rack gear and the pinion gear, and provides an effect on a load applied to the guiding member from a direction which is perpendicular to each of the sheet movement direction and the sheet width direction; and
a tray that covers the rack gear, the pinion gear, and the holder from the direction which is perpendicular to each of the sheet movement direction and the sheet width direction, and receives a load of a sheet medium; and
a transfer section that moves the toner image formed by the imaging forming section to one sheet medium provided from the sheet cassette.
